(19) United States
(12) Patent Application Publication
(10) Pub. No.: US 2023/0400384 A1
(43) Pub. Date: Dec. 14, 2023

(54) ABNORMALITY DETECTION DEVICE WHICH DETECTS ABNORMALITIES IN POWER TRANSMISSION MECHANISM FOR TRANSMITTING ROTATIONAL FORCE OUTPUTTED BY MOTOR

(71) Applicant: Fanuc Corporation, Minamitsuru-gun, Yamanashi (JP)

(72) Inventor: Yoshiaki Yokoyama, Minamitsuru-gun, Yamanashi (JP)

(73) Assignee: Fanuc Corporation, Minamitsuru-gun, Yamanashi (JP)

(21) Appl. No.: 18/034,940

(22) PCT Filed: Nov. 8, 2021
(86) PCT No.: PCT/JP2021/041030

§ 371 Date: May 2, 2023

(30) Foreign Application Priority Data
Nov. 12, 2020 (JP) 2020-188736

(51) Int. Cl. G01M 13/022; G01D 5/12; B25J 19/00

(52) U.S. Cl. CPC G01M 13/022; G01D 5/12; B25J 19/0095

(57) ABSTRACT

This abnormality detection device is provided with a first encoder for detecting the rotation angle of an input shaft of a decelerator, and a second encoder for detecting the rotation angle of an output shaft of the decelerator. An operation control unit controls a servo motor such that the position acquired from the output of the second encoder corresponds to a position determined by an operation program. A detection unit calculates the angle difference, which is the difference between the rotation angle acquired from output of the first encoder and the rotation angle acquired from output of the second encoder. The detection unit determines whether or not the decelerator is abnormal on the basis of the angle difference.

### CROSS REFERENCE TO RELATED APPLICATIONS

This is the U.S. National Phase application of PCT/JP2021/041030, filed Nov. 8, 2021, which claims priority to Japanese Patent Application No. 2020-188736, filed Nov. 12, 2020, the disclosures of each of these applications being incorporated herein by reference in their entireties for all purposes.

### FIELD OF THE INVENTION

The present invention relates to an abnormality detection device for detecting an abnormality in a power transmission mechanism that transmits a rotational force output by an electric motor.

### BACKGROUND OF THE INVENTION

The rotational force output from the electric motor is transmitted to another member via the power transmission mechanism. As a power transmission mechanism, for example, a speed reducer is known that increases the rotational force output from the electric motor and transmits it to another member.

When the power transmission mechanism such as the speed reducer is used for a long period of time, the internal parts thereof will deteriorate and break down. In conventional technologies, it is known to detect an abnormality in a power transmission mechanism by attaching a sensor for detecting a failure to a machine, or analyzing a command value for driving an electric motor output by a controller (see, for example, JP S63-145507 A, JP 2013-152166 A, and JP 2006-102889 A).

Further, in conventional technologies, a control operation in which a rotation angle is obtained from an encoder attached to the electric motor is known, and tooth skipping of a gear arranged inside the speed reducer is detected based on the rotation angle (see, for example, JP 2020-104177 A and WO 2014/098008 A1). Further, as a method of using an encoder attached to a motor, there is known a control operation in which an encoder is arranged on an output shaft of a speed reducer, and positional deviation due to torsion occurring in the speed reducer is corrected (see, for example, JP 2012-171069 A).

### PATENT LITERATURE

[PTL 1] JP 563-145507 A
[PTL 2] JP 2013-152166 A
[PTL 3] JP 2006-102889 A
[PTL 4] JP 2020-104177 A
[PTL 5] WO 2014/098008 A1
[PTL 6] JP 2012-171069 A

### SUMMARY OF THE INVENTION

Electric motors and power transmission mechanisms are disposed in many machines. For example, in an articulated robot, a mechanism is known in which a speed reducer reduces a rotational force output by an electric motor at each joint when a member, such as an arm, is rotated.

Parts inside the power transmission mechanism are driven in contact with each other. The parts inside the power transmission mechanism may wear out. As a result, backlash (play) between the internal parts increases. For example, the wear of gears increases the backlash between the gears. As the wear of the internal parts progresses, the power transmission device breaks down, and then cannot be used.

Machines may be used in production lines for manufacturing products. In this respect, if any of the machines suddenly breaks down, the production line using the machine will be greatly affected. Alternatively, when electric motors and power transmission mechanisms are used in a carrier machine, a desired carrying operation cannot be performed if the carrier machine breaks down. It is preferable that unexpected failures do not occur in the machine provided with the electric motors and the power transmission mechanisms. It is preferable that an abnormality in the power transmission mechanism can be detected before failures that render the machine unusable occur.

An abnormality detection device according to a first aspect of the present disclosure detects an abnormality in a power transmission mechanism that transmits a rotational force output by an electric motor. The abnormality detection device includes a first rotational position detector for detecting a rotation angle of an input shaft of the power transmission mechanism, a second rotational position detector for detecting a rotation angle of an output shaft of the power transmission mechanism, and an operation control unit for controlling an operation of the electric motor. The abnormality detection device includes a detection unit for detecting an abnormality in the power transmission mechanism based on the output of the first rotational position detector and the output of the second rotational position detector. The operation control unit controls the electric motor so that the position obtained from the output of the second rotational position detector corresponds to the position defined in an operation program. The detection unit includes a variable setting unit for setting a variable including an angle difference, i.e., a difference between the rotation angle obtained from the output of the first rotational position detector and the rotation angle obtained from the output of the second rotational position detector, based on the output of the first rotational position detector, the output of the second rotational position detector, and a reduction ratio of the power transmission mechanism. The detection unit includes a determination unit for determining whether the power transmission mechanism is abnormal based on the variable.

An abnormality detection device according to a second aspect of the present disclosure detects an abnormality in a power transmission mechanism that transmits a rotational force output by an electric motor. The abnormality detection device includes a first rotational position detector for detecting a rotation angle of an input shaft of the power transmission mechanism, a second rotational position detector for detecting a rotation angle of an output shaft of the power transmission mechanism, and an operation control unit for controlling an operation of the electric motor. The abnormality detection device includes a detection unit for detecting an abnormality in the power transmission mechanism based on the output of the first rotational position detector. The operation control unit controls the electric motor so that the position obtained from the output of the second rotational position detector corresponds to the position defined in an operation program. The detection unit includes a variable setting unit for setting variables that include the rotation angle obtained from the output of the first rotational position detector but do not include the rotation angle obtained from the output of the second rotational position detector. The detection unit includes a determination unit for determining whether the power transmission mechanism is abnormal based on the variables.

According to an aspect of the present disclosure, it is possible to provide an abnormality detection device that accurately detects an abnormality in a power transmission mechanism.

### BRIEF DESCRIPTION OF DRAWINGS

FIG. 1 is a schematic view of a robot according to an embodiment.

FIG. 2 is a block diagram of a robot apparatus according to an embodiment.

FIG. 3 is an enlarged partial sectional view of a joint of the robot according to the embodiment.

FIG. 4 is a graph showing an operation pattern of a servomotor.

FIG. 5 is a graph of a rotation angle based on an output of an encoder when a speed reducer is new.

FIG. 6 is a graph of the rotation angle based on the output of the encoder when the wear of the gear of the speed reducer progresses.

FIG. 7 is an enlarged view of a portion A in FIG. 6.

FIG. 8 is a first enlarged sectional view of a portion where the teeth of two gears are in contact.

FIG. 9 is a second enlarged sectional view of a portion where the teeth of two gears are in contact.

FIG. 10 is a first graph of the variable for determining an abnormality of the speed reducer with respect to the number of executions of work of the robot apparatus.

FIG. 11 is a second graph of the variable for the number of executions of work of the robot apparatus.

FIG. 12 is a graph of the amount of increase in variables with respect to the number of executions of work of the robot apparatus.

FIG. 13 is a graph explaining a control operation for predicting when an abnormality will occur in the speed reducer based on changes in variables.

FIG. 14 is a graph showing another operating pattern of the servomotor.

FIG. 15 is a side view of the robot, which explains the operation for calculating the constant of proportionality between the torque acting on the speed reducer and the torsion angle of the speed reducer.

FIG. 16 is a graph explaining a control operation for detecting an abnormality based on the output of the first encoder.

FIG. 17 is an enlarged view of a portion B in FIG. 16.

FIG. 18 is a graph showing the rotation angle in the initial state obtained from the output of the first encoder and the rotation angle after long-time driving.

FIG. 19 is a side view of a machine, which explains another power transmission mechanism in an embodiment.

### DETAILED DESCRIPTION OF EMBODIMENTS OF THE INVENTION

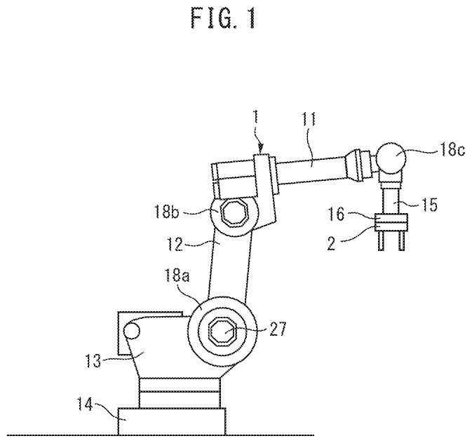

Referring to FIGS. 1 to 19, an abnormality detection device for detecting an abnormality in a power transmission mechanism according to an embodiment will be described. The power transmission mechanism transmits a rotational force output by an electric motor to another member. The electric motor and the power transmission mechanism are disposed in various machines, such as machines that convey objects, move objects, or manufacture objects. In this embodiment, a robot will be described as an example of a machine. Further, as an example of the power transmission mechanism, a speed reducer disposed at a joint of the robot will be described.

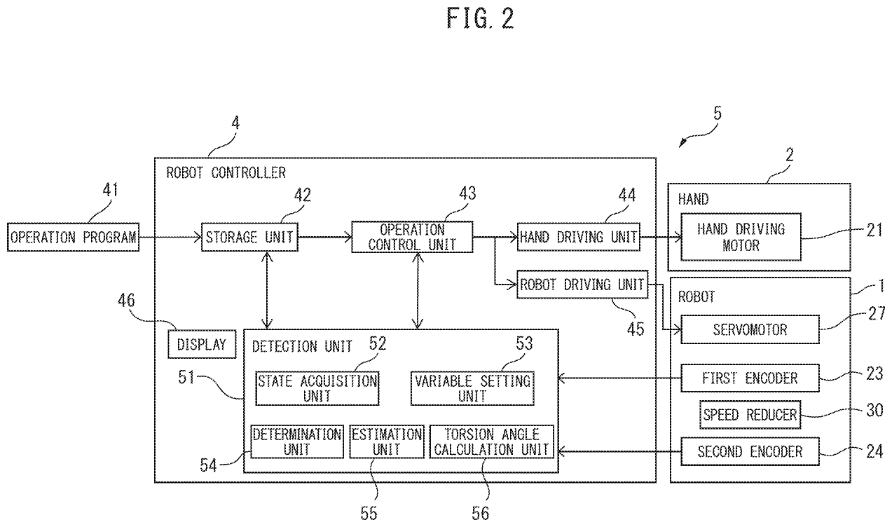

FIG. 1 is a schematic view of a robot apparatus according to this embodiment. FIG. 2 is a block diagram of the robot apparatus according to this embodiment. Referring to FIGS. 1 and 2, a robot apparatus 5 of this embodiment conveys a workpiece. The robot apparatus 5 includes a hand 2 as a work tool for grasping a workpiece and a robot 1 for moving the hand 2. The robot 1 of this embodiment is an articulated robot including a plurality of joints 18a, 18b, and 18c.

The robot 1 includes a base portion 14 secured to an installation surface and a swivel base 13 supported by the base portion 14. The swivel base 13 rotates with respect to the base portion 14. The robot 1 includes an upper arm 11 and a lower arm 12. The lower arm 12 is supported by the swivel base 13 via a joint 18a. The upper arm 11 is supported by the lower arm 12 via a joint 18b. The robot 1 includes a wrist 15 connected to an end of the upper arm 11. The wrist 15 is supported by the upper arm 11 via a joint 18c. The wrist 15 includes a flange 16 to which the hand 2 is secured.

Each component, such as the upper arm 11 and the lower arm 12, is formed so as to rotate about a predetermined drive axis. The robot 1 of this embodiment has six drive axes. The robot 1 includes a servomotor 27 as an electric motor for driving respective components, and a speed reducer 30. In this embodiment, the servomotor 27 and the speed reducer 30 are arranged for respective drive axes.

The hand 2 of this embodiment includes a hand driving motor 21 that drives the hand 2. As the hand driving motor 21 is driven, a claw portion of the hand 2 is opened and closed. Note that the claw portion may be formed so as to be operated by air pressure. Further, any work tool can be attached to the robot in accordance with the work to be performed by the robot apparatus.

The robot apparatus 5 includes a robot controller 4 that controls the robot 1 and the hand 2. The robot controller 4 includes an arithmetic processing device (computer) having a CPU (Central Processing Unit) as a processor. The arithmetic processing unit has a RAM (Random Access Memory), a ROM (Read Only Memory), etc., which are connected to the CPU via a bus. An operation program 41 previously made for controlling the robot 1 and the hand 2 is input to the robot controller 4. The robot 1 and the hand 2 are controlled based on the operation program 41.

The robot controller 4 includes a storage unit 42 that stores predetermined information. The storage unit 42 stores information regarding control operations for the robot 1 and the hand 2. The storage unit 42 can be composed of a non-temporary recording medium capable of storing information, such as a volatile memory, a non-volatile memory, or a hard disk. The robot controller 4 includes a display 46 that displays any information regarding the robot apparatus 5. The display 46 can be composed of a display panel such as a liquid crystal display panel.

The robot controller 4 includes an operation control unit 43 that sends operation commands for the robot 1 and the hand 2. The operation control unit 43 controls the operation of the servomotor 27 and the operation of the hand driving motor 21. The operation control unit 43 corresponds to a processor to be driven in accordance with the operation program 41. The operation control unit 43 is formed so as to be able to read information stored in the storage unit 42. The processor functions as an operation control unit 43 by reading the operation program 41 stored in the storage unit 42 and performing a control operation defined in the operation program 41.

The operation control unit 43 sends an operation command for driving the robot 1 to the robot driving unit 45 based on the operation program 41. The robot driving unit 45 includes an electric circuit for driving the servomotor 27. The robot driving unit 45 supplies electricity to the servomotor 27 based on the operation command. Further, the operation control unit 43 sends an operation command for driving the hand 2 to the hand driving unit 44 based on the operation program 41. The hand driving unit 44 includes an electric circuit for driving the hand driving motor 21. The hand driving unit 44 supplies electricity to the hand driving motor 21 based on the operation command.

In the robot apparatus 5 of this embodiment, a speed reducer 30 as a power transmission mechanism is disposed at a joint of the robot 1. The robot apparatus 5 includes an abnormality detection device for detecting an abnormality in the speed reducer 30. The abnormality detection device of this embodiment includes a robot controller 4, a first encoder 23 as a first rotational position detector for detecting a rotation angle of the output shaft of the servomotor 27, and a second encoder 24 as a second rotational position detector for detecting a rotation angle of the output shaft of the speed reducer 30. In this embodiment, the rotation angle of the output shaft of the servomotor 27 corresponds to the rotation angle of the input shaft of the speed reducer 30.

The robot controller 4 includes a detection unit 51 for detecting an abnormality in the speed reducer 30 based on the output of the first encoder 23 and the output of the second encoder 24. The detection unit 51 includes a state acquisition unit 52 for acquiring the operating state of the robot. The detection unit 51 includes a variable setting unit 53 that sets variables for determining an abnormality of the speed reducer 30. The detection unit 51 includes a determination unit 54 that determines whether the speed reducer 30 is abnormal based on the variables. The detection unit 51 includes an estimation unit 55 that estimates the number of executions or the drive time of work that may cause an abnormality in the future. The detection unit 51 includes a torsion angle calculation unit 56 that calculates the torsion angle between the input shaft and the output shaft of the speed reducer 30 based on the torque applied to the speed reducer 30.

The detection unit 51 described above corresponds to a processor to be driven in accordance with the operation program 41. The state acquisition unit 52, the variable setting unit 53, the determination unit 54, the estimation unit 55, and the torsion angle calculation unit 56, which are included in the detection unit 51, correspond to processors to be driven in accordance with the operation program 41. The processors read the operation program 41 and perform control operations defined in the operation program 41, thereby functioning as the respective units.

In this embodiment, the servomotor 27 as an electric motor and the speed reducer 30 as a power transmission mechanism, which are arranged at the joint 18a between the swivel base 13 and the lower arm 12, among the plurality of joints 18a, 18b, and 18c, will be described.

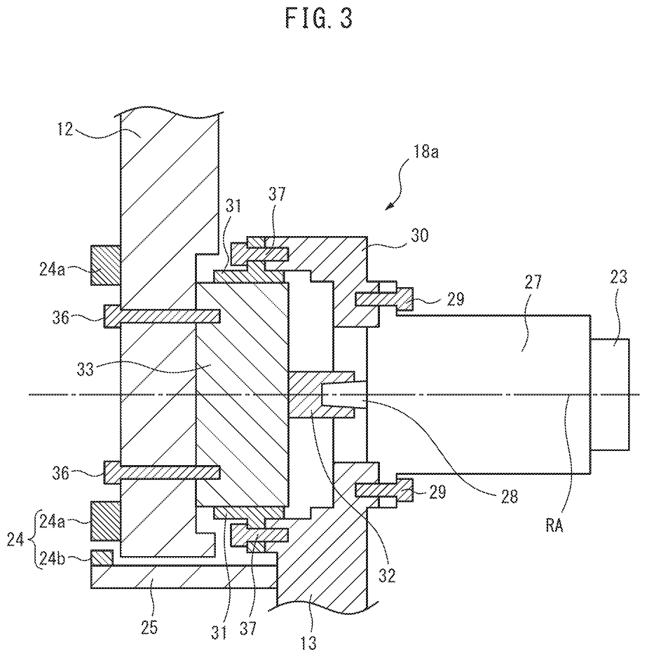

FIG. 3 is an enlarged partial sectional view of a joint disposed between the swivel base and the lower arm. In the joint 18a of this embodiment, the lower arm 12 rotates with respect to the swivel base 13. The servomotor 27 that drives the lower arm 12 with respect to the swivel base 13 and the speed reducer 30 that increases the output torque of the servomotor 27 are arranged at the joint 18a.

The servomotor 27 is secured to the swivel base 13 by bolts 29. The servomotor 27 includes an output shaft 28 that protrudes toward the speed reducer 30 and outputs a rotational force. The speed reducer 30 includes an input shaft 32 to which the rotational force of the output shaft 28 of the servomotor 27 is input.

The speed reducer 30 can reduce the rotational speed of the input shaft 32 of the speed reducer 30 and increase the rotational torque. The speed reducer 30 includes a plurality of gears that transmit the rotational force of the input shaft 32 and an output shaft 33 that supports the plurality of gears. The speed reducer 30 includes a speed reducer case 31 formed so as to surround the output shaft 33. The speed reducer case 31 is formed in a cylindrical shape. The input shaft 32 is rotatably supported by the output shaft 33. The output shaft 33 is supported so as to rotate relative to the speed reducer case 31.

The speed reducer case 31 is secured to the swivel base 13 by bolts 37. Further, the output shaft 33 of the speed reducer 30 is secured to the lower arm 12 by bolts 36. The input shaft 32 of the speed reducer 30 is coupled to the output shaft 28 of the servomotor 27. The output shaft 28 and the input shaft 32 rotate around a rotation axis RA. The rotation axis RA is the rotation axis of the joint 18a.

In an example of the speed reducer 30 here, the speed reducer case 31 is stationary. When the input shaft 32 rotates, the output shaft 33 rotates with respect to the speed reducer case 31 due to the transmission of the rotational force of the gears. The lower arm 12 rotates together with the output shaft 33. As such a speed reducer 30, for example, an eccentric oscillation-type planetary gear speed reducer can be employed. Note that the speed reducer is not limited to this type, and a speed reducer having any mechanism for changing the rotational force can be employed.

Referring to FIGS. 2 and 3, the first encoder 23 for detecting the rotational position of the output shaft 28 of the servomotor 27 is attached to the servomotor 27. The rotational position of the output shaft 28 of the servomotor 27 corresponds to the rotational position of the input shaft 32 of the speed reducer 30. That is, the first encoder 23 is disposed so as to detect the rotational position of the input shaft 32 of the speed reducer 30.

In the robot apparatus 5 of this embodiment, in addition to the first encoder 23, a second encoder 24 for detecting the rotational position of the output shaft 33 of the speed reducer 30 is disposed. The second encoder 24 has a scale 24a and a detector 24b disposed so as to face the scale 24a. The scale 24a is secured to the surface of the lower arm 12. The scale 24a has a shape extending in the circumferential direction around the rotation axis RA.

The detector 24b is supported by the swivel base 13 via a support member 25. In the second encoder 24, a magnetic ring can be used as the scale 24a, and a magnetic sensor can be used as the detector 24b. For example, the surface of the scale 24a, which faces the detector 24b, can be magnetized with S pole and N pole at regular intervals so that the detector 24b can detect changes in magnetic flux. The second encoder is not limited to this embodiment, and an optical encoder may be employed.

Further, in the second encoder 24 of this embodiment, the scale 24a is attached to the surface of the lower arm 12, but the present invention is not limited to this embodiment. The second encoder can be disposed at any position so as to detect the rotational position of the output shaft of the speed reducer. For example, the scale may be attached to the output shaft of the speed reducer. Note that the first encoder and the second encoder may be incremental or absolute encoders.

The operation control unit 43 of this embodiment controls the rotational position of the servomotor 27 in order to control the position of the robot 1. The position of the robot 1 is, for example, the position of the tool tip point of the working tool. The position of the tip point of the work tool is determined by the position and posture of the swivel base 13, the lower arm 12, the upper arm 11, and the wrist 15.

In general, the control operation for the rotational position of the servomotor 27 is performed based on the rotational position output from the first encoder 23. However, in the speed reducer, slip (backlash of gears, etc.) exists between internal parts. Further, a driving force is applied to the parts of the speed reducer, and accordingly, the parts may be deformed or distorted. As a result, torsion may occur between the input shaft and the output shaft of the speed reducer. Thus, the rotational position of the output shaft 33 of the speed reducer 30 may deviate from the rotational position of the output shaft 28 of the servomotor 27. In this embodiment, the second encoder 24 for detecting the rotational position of the output shaft 33 of the speed reducer 30 is disposed in order to accurately detect the position of the robot 1.

Referring to FIG. 2, the operation control unit 43 of this embodiment controls the position and posture of the robot 1 based on the rotational position output from the second encoder 24. The operation control unit 43 generates a position command for the servomotor 27 based on the operation program 41. In this respect, the operation control unit 43 acquires the rotational position from the second encoder 24. The operation control unit 43 generates a position command so that the rotational position output from the second encoder 24 corresponds to the position defined in the operation program 41. Thus, a position feedback control operation can be performed.

Further, the operation control unit 43 generates a speed command based on the position command. For the speed command, the operation control unit 43 also calculates the rotational speed based on the rotational position output from the second encoder 24. The operation control unit 43 generates a speed command so that the actual rotation speed corresponds to the rotation speed based on the operation program 41. Thus, a speed feedback control operation can be performed.

By controlling the position and posture of the robot 1 based on the output of the second encoder 24 that detects the rotational position of the output shaft 33 of the speed reducer 30, the accuracy of the position and posture of the robot 1 is improved. Further, the accuracy of a movement path, along which the robot 1 moves, is improved.

The detection unit 51 of the abnormality detection device determines abnormalities of the parts arranged inside the speed reducer 30. In particular, the detection unit 51 detects abnormalities due to wear of the parts. The operation of the robot 1 causes the gears arranged inside the speed reducer 30 to wear. Further, bearings arranged inside the speed reducer 30 may wear. For example, if rolling bearings are arranged in the speed reducer, the operation of the robot may cause the rolling elements or bearing rings of the rolling bearings to wear.

Due to the wear of the parts, the backlash that exists between the parts increases. For example, when the wear of the gears increases, tooth skipping or the like occurs and the speed reducer breaks down. Alternatively, if the wear of the parts increases, there is a risk that the position and posture of the robot 1 cannot be accurately controlled. The detection unit 51 of this embodiment detects an abnormality such as an increase in backlash of the parts that occurs before a large abnormality such as tooth skipping.

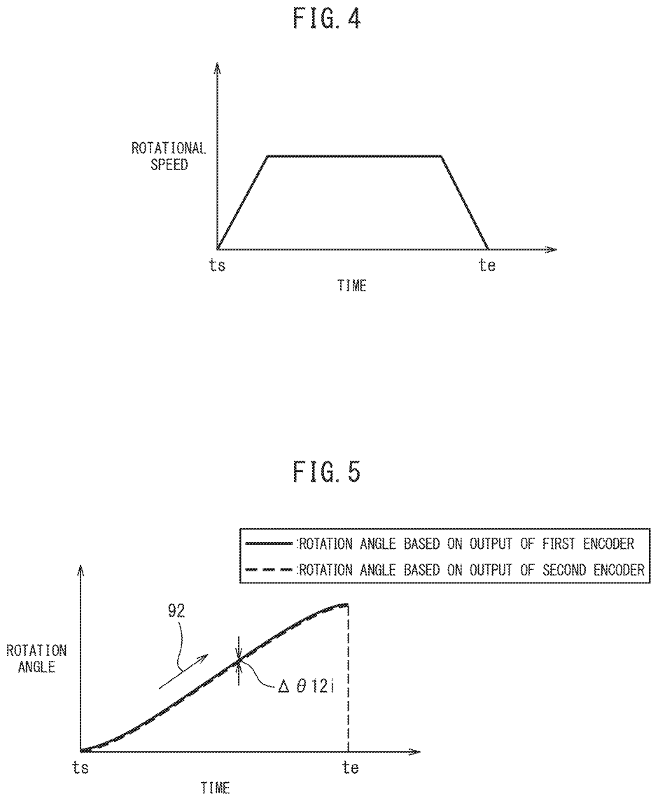

FIG. 4 shows a graph explaining one operation pattern of the servomotor in this embodiment. The robot apparatus 5 repeats a task for transporting a workpiece. The robot 1 changes its position and posture in various patterns. FIG. 4 shows the operation of the servomotor 27 corresponding to one operation of the robot 1. The servomotor 27 reaches a predetermined rotational speed after being activated at time ts. The servomotor 27 stops at time te after being driven at a constant rotational speed. Such an operation pattern of the servomotor 27 is previously selected in order to detect an abnormality in the speed reducer 30.

FIG. 5 shows a graph of the rotation angle based on the output of the encoder when the servomotor is driven in the operation pattern shown in FIG. 4. The operation starts at time ts and ends at time te. The rotation angle indicates the amount of rotation caused by the motor. For example, when the output shaft rotates once, the rotation angle is 360°. The rotation angle obtained from the output of each encoder increases over time as indicated by arrow 92.

FIG. 5 shows the rotation angle based on the output of the first encoder 23 and the rotation angle based on the output of the second encoder 24 in one operation of the robot. Here, the rotation angle of the input shaft 32 of the speed reducer 30 is calculated from the rotational position output from the first encoder 23. Subsequently, the rotation angle of the input shaft 32 is divided by the speed reduction ratio of the speed reducer 30, and then, compared with the rotation angle based on the rotational position output from the second encoder 24. Note that the rotation angle based on the output of the second encoder may be multiplied by the speed reduction ratio, and compared with the rotation angle based on the output of the first encoder.

In a first abnormality detection control operation of this embodiment, whether the speed reducer 30 is abnormal is determined based on the output of the first encoder 23 and the output of the second encoder 24. Referring to FIG. 2, the state acquisition unit 52 of the detection unit 51 detects the rotational position output from the first encoder 23 and the rotational position output from the second encoder 24 while the servomotor 27 is driven. The state acquisition unit 52 stores the acquired rotational positions of the respective encoders in the storage unit 42.

FIG. 5 shows the rotation angle when the speed reducer 30 is normal. Here, the rotation angle in the initial state when the speed reducer 30 is new is shown. There is little backlash between the parts of the speed reducer 30. Thus, if there is little torsion between the input shaft and the output shaft of the speed reducer 30, the rotation angle obtained from the output of the first encoder 23 and the rotation angle obtained from the output of the second encoder 24 are almost the same. In this embodiment, the difference between the rotation angle obtained from the output of the first encoder 23 and the rotation angle obtained from the output of the second encoder 24 is referred as an angle difference. For example, the angle difference corresponds to a value obtained by subtracting the rotation angle θ2 obtained from the output of the second encoder 24 from the rotation angle θ1 obtained from the output of the first encoder 23 (θ1-θ2). In FIG. 5, there is a slight angular difference Δθ12i between the rotation angles.

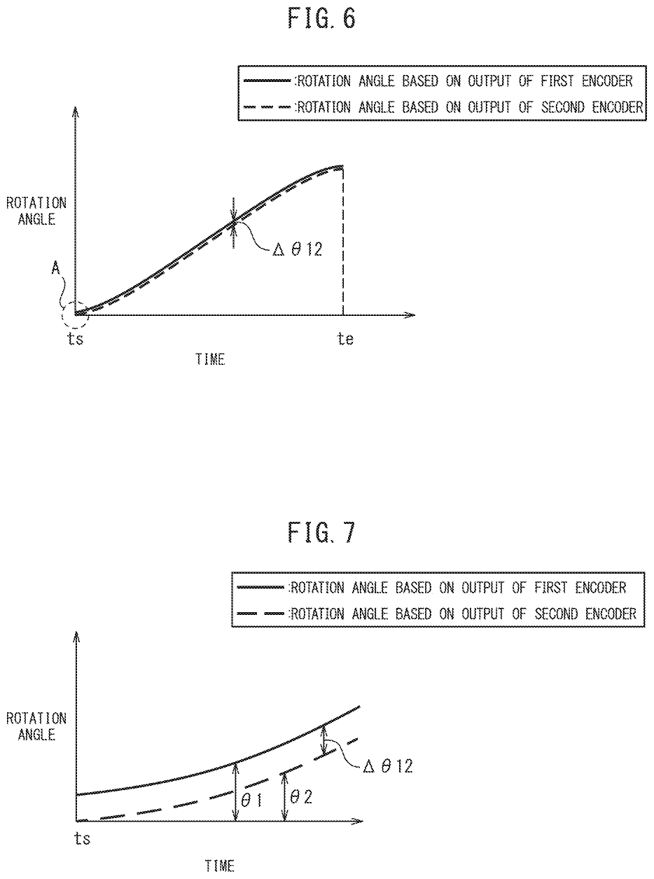

FIG. 6 shows a graph of the rotation angle based on the output of the encoder when the wear of the parts of the speed reducer progresses. FIG. 7 shows an enlarged view of the part A in FIG. 6. FIG. 7 is a graph in the vicinity of the time ts when measurement of the rotation angle begins. Referring to FIGS. 6 and 7, in this embodiment, the rotational position (phase) output from the second encoder 24 with respect to the rotational position (phase) output from the first encoder 23 when there is no wear of the parts is previously measured. Thus, it is possible to calculate the amount of change in the angle difference when the wear progresses during the period from time ts to time te in which the servomotor 27 rotates.

Further, in this embodiment, the position of the robot 1 is controlled based on the output of the second encoder 24. In the graphs of FIGS. 5 to 7, the rotation angle obtained from the output of the second encoder 24 is set to 0 at time ts when a predetermined operation of the robot 1 begins.

When the drive time of the speed reducer 30 increases, the parts such as gears and bearings wear out. As a result, the difference between the rotation angle obtained from the output of the first encoder 23 and the rotation angle obtained from the output of the second encoder 24 increases. That is, the absolute value of the angular difference increases. In FIGS. 6 and 7, an angular difference Δθ12 is generated based on the rotation angle θ1 obtained from the output of the first encoder 23 and the rotation angle θ2 obtained from the output of the second encoder 24. Here, when the angular difference Δθ12 is defined as (θ1-θ2), the angular difference Δθ12 may be a positive number or a negative number depending on the contact state of the gear teeth.

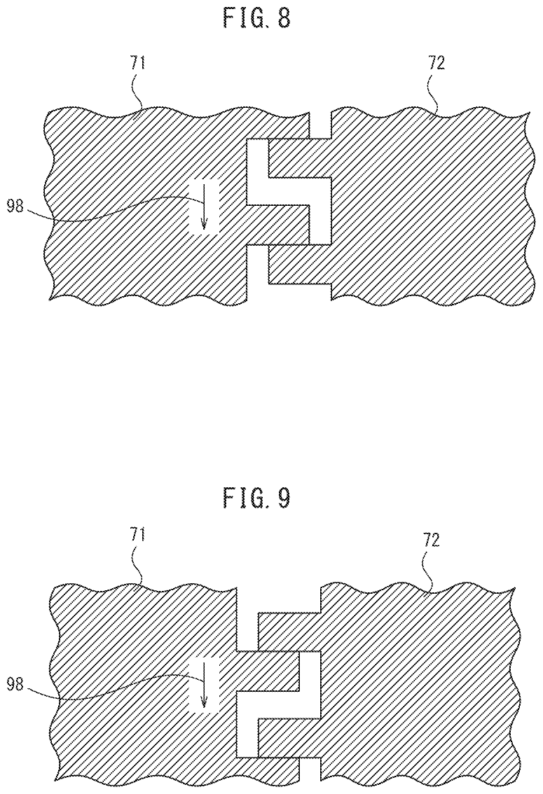

FIG. 8 shows a first enlarged sectional view of the portion at which the teeth of the two gears are in contact. FIG. 9 shows a second enlarged sectional view of the portion at which the teeth of the two gears are in contact. FIGS. 8 and 9 are schematic views showing the difference in the contact state between the gear teeth facing each other. In FIGS. 8 and 9, the gear 71 on the input side rotates in the direction indicated by arrow 98. The teeth of the gear 71 on the input side shown in FIG. 8 are in contact with the teeth of the gear 72 on the output side at the tooth flanks on the side of the rotational direction. On the other hand, in FIG. 9, the teeth of the gear 71 on the input side are in contact with the teeth of the gear 72 on the output side at the tooth flanks on the side opposite to the rotational direction. The differences in the contact state of these teeth are caused by gravity, inertial force when the robot moves, or other external forces.

As shown in FIG. 8, when the teeth of the gear 71 on the input side come into contact with the teeth of the gear 72 on the output side at the tooth flanks on the side of the rotational direction, the rotation angle θ1 is greater than the rotation angle θ2 in order to obtain the orientation of the lower arm 12 on the output side. As a result, the angular difference Δθ12 is a positive value. Further, as shown in FIG. 9, when the teeth of the gear 71 on the input side come into contact with the teeth of the gear 72 on the output side at the tooth flanks on the side opposite to the rotational direction, the rotation angle θ1 is smaller than the rotation angle θ2. As a result, the angular difference Δθ12 is a negative number.

Note that the angular difference is not limited to a value obtained by subtracting the rotation angle θ2 obtained from the output of the second encoder 24 from the rotation angle θ1 obtained from the output of the first encoder 23 (θ1-θ2), and a value obtained by subtracting the rotation angle θ1 from the angle θ2 (θ2-θ1) may be used. Alternatively, the absolute value of a value obtained by subtracting one form the other of the rotation angle obtained from the output of the first encoder 23 and the rotation angle obtained from the output of the second encoder 24 may be used. In this embodiment, an example in which the angular difference Δθ12 is (01-02) and the gears are in contact as shown in FIG. 8 will be described.

In the first abnormality detection control operation, an abnormality of the speed reducer 30 is detected based on variables including the angular difference. The variables in this embodiment are evaluation variables for evaluating whether the speed reducer 30 is abnormal. The variable setting unit 53 calculates the angular difference Δθ12 as a first variable. The variable setting unit 53 divides the rotation angle obtained from the output of the first encoder 23 by the speed reduction ratio of the speed reducer 30. The variable setting unit 53 calculates the angular difference Δθ12 by subtracting the rotation angle obtained from the output of the second encoder 24 from this rotation angle. Subsequently, the determination unit 54 determines whether an abnormality occurs in the speed reducer 30.

The variable setting unit 53 can employ the maximum value of the angular difference Δθ12 from time ts to time te as the angular difference Δθ12 used for determining an abnormality. Alternatively, a plurality of times may be set and an average value of variables at the plurality of times may be employed. Further, the angular difference Δθ12 may be converted into an absolute value before the maximum value or average value is calculated. Thus, the variable used for determining an abnormality can be employed as the maximum value or average value obtained when the operation pattern of the servomotor 27 is executed.

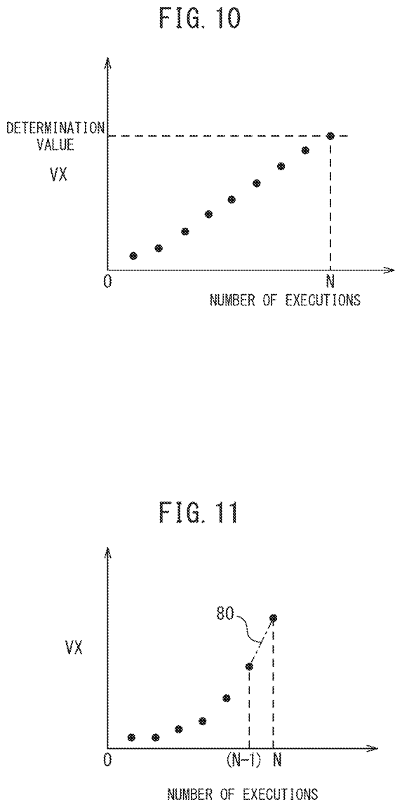

FIG. 10 shows a graph of the variable for the number of executions of the operation of the robot. The horizontal axis is the number of executions of a predetermined operation of the robot 1. The horizontal axis corresponds to, for example, the number of executions of a predetermined operation of the servomotor 27 shown in FIG. 4. Note that the horizontal axis may be the drive time during which the robot 1 performs a predetermined operation. The vertical axis is the variable for determining whether an abnormality occurs in the speed reducer 30.

In a first determination control operation of this embodiment, it is determined that the speed reducer 30 is abnormal when the variable VX deviates from a predetermined determination range. As the number of executions increases, the variable VX gradually increases. In the example shown in FIG. 10, when the number of executions reaches N, the variable VX exceeds the determination value of a predetermined variable. The determination unit 54 determines that an abnormality occurs when the variable VX exceeds the determination value. Here, the determination unit 54 determines that an abnormality occurs when the number of executions N is completed. For example, it can be determined that the speed reducer 30 is abnormal when the angular difference Δθ12 as the first variable exceeds the determination value. Alternatively, the determination unit 54 can determine that the wear of the gears progresses.

FIG. 11 shows another graph of the variable for the number of executions of the operation of the robot. In a second determination control operation of this embodiment, the determination unit 54 determines that the speed reducer 30 is abnormal when the rate of change of the variable VX for the number of executions of work deviates from a predetermined determination range. In this example, the gradient between the variable VX at the number of executions (N-1) and the variable VX at the number of executions N is calculated.

The determination unit 54 determines that the speed reducer 30 is abnormal when the gradient of the variable VX exceeds a predetermined determination value. That is, the determination unit 54 determines that the speed reducer 30 is abnormal when the gradient of the straight line 80 exceeds the determination value. For example, when the rate of change of the angular difference Δθ12 as the first variable exceeds the determination value, it is determined that the speed reducer 30 is abnormal. In the calculation of the rate of change, the rate of change may be calculated based on not only two variables but also three or more variables.

Further, instead of the number of executions, the drive time, during which the robot 1 or the servomotor 27 executes a predetermined operation, may be used. In this respect, the determination unit can determine that the speed reducer is abnormal when the rate of change of the variable with respect to the drive time deviates from a predetermined determination range.

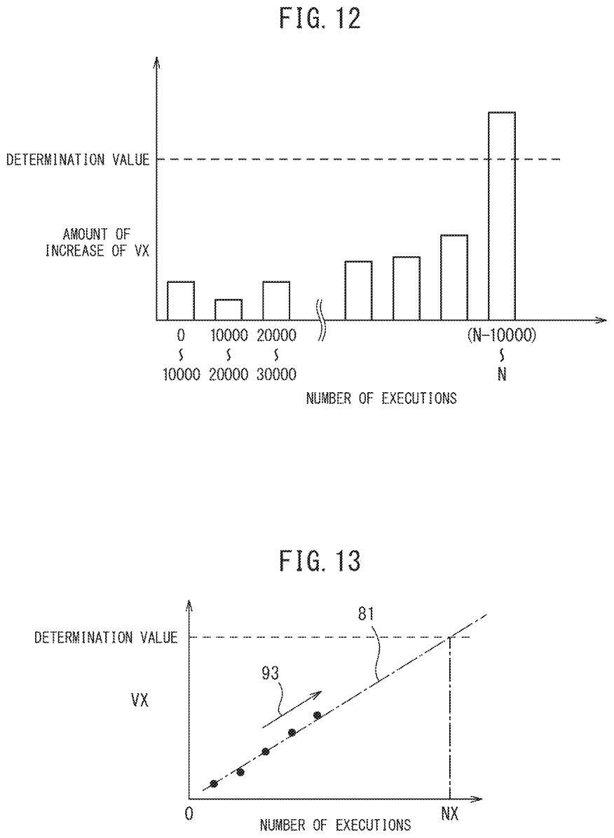

FIG. 12 shows a graph of the amount of increase in variables with respect to the number of executions of the operation of the robot. In a third determination control operation of this embodiment, as in the second determination control operation, an abnormality of the speed reducer is determined based on the rate of change of the variables with respect to the number of executions or the drive time of work.

The determination unit 54 calculates the amount of increase in the variable VX for each number of times a predetermined operation is performed. Here, the amount of increase in the variable VX is calculated every 10,000 operations of the robot 1. The amount of increase in the variable VX increases as the number of executions increases. The determination unit 54 determines that the speed reducer is abnormal when the amount of increase in the variable VX deviates from a predetermined determination range. For example, the determination unit 54 can determine that the speed reducer 30 is abnormal when the amount of increase in the angular difference Δθ12 per 10,000 operations exceeds a predetermined determination value. In this example, the determination unit 54 can determine that an abnormality occurs in the speed reducer when the number of executions reaches N times. When the rate of change of the variable with respect to the drive time is calculated, the amount of increase in the variable can be calculated for each predetermined length of the drive time.

Subsequently, the estimation unit 55 of the detection unit 51 of this embodiment will be described. The estimation unit 55 performs an estimation control operation for estimating the number of executions or the drive time of work in which an abnormality will occur in the future, based on the value of the variable for the number of executions or the drive time of the past work.

FIG. 13 shows a graph of the variable for the number of executions of the operation of the robot. FIG. 13 is a graph explaining a control operation for estimating the number of executions of work in which an abnormality occurs in the estimation unit 55. The variable VX increases as the number of executions increases, as indicated by arrow 93. The estimation unit 55 calculates an approximation line 81 that indicates a trend of change of the variable, based on the value of the variable with respect to the number of executions of the past work. For example, an approximation line can be calculated for the angular difference Δθ12 as the first variable.

The estimation unit 55 can generate an approximation line that indicates a trend of change under any control operation. In the example shown in FIG. 13, an approximation line 81 that is a straight line is generated by a least squares method using all past values of the variable VX. The approximation line is not limited to a straight line, and may be a curved line. Further, when the approximation line is generated, a predetermined number of variables may be selected in order to generate the approximation line.

The estimation unit 55 estimates the number of executions of work in which the approximation line deviates from a predetermined determination range as the number of executions of work in which an abnormality will occur in the future. In this example, the number of executions NX in which the approximation line 81 exceeds a predetermined determination value is estimated as the number of executions in which an abnormality occurs. Note that the estimation unit 55 may employ the drive time instead of the number of executions. That is, the estimation unit may calculate an approximation line that indicates the trend of change of the variable with respect to the drive time, and estimate the drive time in which the approximation line deviates from the determination range as the drive time in which an abnormality occurs.

Referring to FIG. 2, the information regarding the abnormality detected by the detection unit 51 can be displayed on the display 46. An operator can check the information regarding the abnormality displayed on the display 46 and plan the maintenance or inspection for the speed reducer 30. As a result, a sudden failure of the speed reducer 30 can be avoided.

Subsequently, variables for determining an abnormality in the speed reducer 30 will be described. The variable VX is not limited to the angular difference as the first variable, and a variable including the angular difference can be employed. Referring to FIGS. 5 and 6, the variable setting unit 53 calculates, as a second variable VX, the difference (Δθ12-Δθ12i) between the angular difference Δθ12i when the speed reducer 30 is normal and the current angular difference Δθ12 of the speed reducer 30. Alternatively, the variable setting unit 53 can calculate, as a third variable VX, the ratio (Δθ12/Δθ12i) between a predetermined angular difference when the speed reducer 30 is normal and the current angular difference of the speed reducer. Here, as the predetermined angular difference when the speed reducer 30 is normal, the angular difference in the initial state when the speed reducer 30 is new is used. The variable setting unit 53 can calculate the angular difference when the speed reducer 30 is new and store it in the storage unit 42.

Furthermore, the variable setting unit 53 can calculate, as a fourth variable VX, a value (Δθ12-Δθ12i)/Δθ12i) obtained by dividing the difference between the angular difference (Δθ12i) when the speed reducer 30 is normal and the current angular difference (Δθ12) of the speed reducer 30 by the angular difference when the speed reducer 30 is normal.

For any variable, the first determination control operation based on the value of the variable shown in FIG. 10, the second determination control operation based on the rate of change of the variable shown in FIG. 11, or the third determination control operation based on the amount of increase of the variable shown in FIG. 12 can determine the abnormality of the speed reducer 30. Further, the estimation unit 55 can estimate the time in which an abnormality occurs by performing the above-described estimation control operation using each variable.

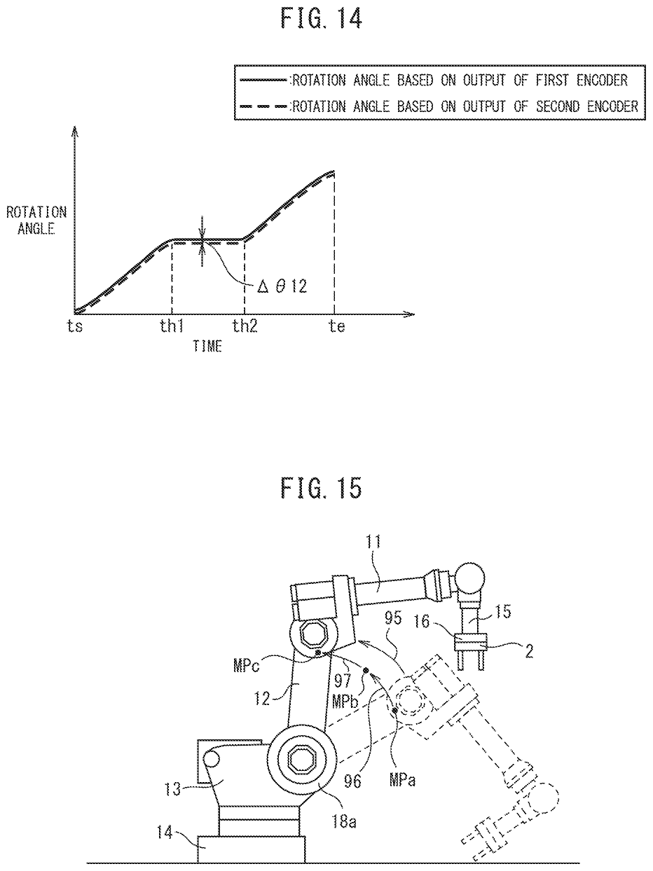

FIG. 14 shows another operation pattern of the servomotor for determining whether an abnormality occurs in the speed reducer. In this operation pattern, the servomotor 27 temporarily stops during the period from time ts to time te. In this example, the servomotor 27 stops at time th1 and starts at time th2. The variable setting unit 53 may calculate variables based on the output of the encoder while the servomotor 27 stops. For example, when the angular difference Δθ12, which is the first variable, is calculated, the variable setting unit 53 may calculate the angular difference Δθ12 while the servomotor 27 stops.

By the way, in the above-mentioned second variable to fourth variable, the angular difference when the speed reducer 30 is normal is included in the variable. For example, in the second variable, the angular difference when the speed reducer 30 is normal is subtracted from the current angular difference of the speed reducer 30. Thus, the effect of torsion in the speed reducer 30 is eliminated. However, the first variable does not include the angular difference when the speed reducer 30 is normal. When the determination control operation is performed using the first variable, the effect of torsion of the speed reducer 30 is included. Subsequently, a control operation for eliminating the effect of torsion in the speed reducer 30 when the first variable is used to determine whether the speed reducer 30 is abnormal or to estimate the time of occurrence of the abnormality will be described.

Referring to FIG. 2, the torsion angle calculation unit 56 of the detector 51 calculates the torsion angle between the input shaft 32 and the output shaft 33 based on the torque applied to the output shaft 33 of the speed reducer 30. The relationship between the torque T acting on the output shaft 33 of the speed reducer and the torsion angle θt of the speed reducer 30 can be expressed by the following formula using a proportionality constant k.

T=k×θt (1)

From the above formula (1), the torsion angle θt can be expressed by formula (2).

θt=T/k (2)

The torque T can be calculated using the previously calculated inertia and the angular velocity of the servomotor 27 when the robot 1 is driven. The inertia can be calculated based on the weight and the position of the center of gravity of the components of the robot 1 and the weight and the position of the center of gravity of a workpiece. When the robot 1 is at rest, the torque T can be calculated for the weight of the components for maintaining the position of the robot 1. Alternatively, the torque T may be calculated using the current value of the servomotor 27. That is, the torque applied to the output shaft 28 of the servomotor 27 is calculated using the current value. The torque T can be calculated by multiplying the torque applied to the output shaft 28 by the reduction ratio.

Subsequently, a method for calculating the proportionality constant k will be described. The relationship between the angular difference Δθ12 based on the output of the first encoder 23 and the output of the second encoder 24 and a backlash component BL, such as backlash caused by wear of the gears of the speed reducer 30, is given by the following formula (3).

Δθ12=θt+BL (3)

Subsequently, the operator actually drives the robot 1. An operation is set in which the direction of backlash does not change with respect to the gears inside the speed reducer 30. The angular difference Δθ12 and the torque T are calculated for a plurality of postures of the robot 1 in this operation.

FIG. 15 shows a schematic view showing the operation of the robot for calculating the proportionality constant between the torque and the torsion angle. Here, the lower arm 12 is rotated as indicated by arrow 95 at the joint 18a. The robot 1 stops in the middle of this rotation operation. That is, the servomotor 27 disposed at the joint 18a temporarily stops.

As indicated by arrow 96, the robot 1 stops when the lower arm 12 rotates from a movement point MPa to a moving point MPb. At the moving point MPb, the torque Ta and the angular difference Δθ12a are calculated. Furthermore, as indicated by arrow 97, the lower arm 12 rotates from the moving point MPb to a moving point MPc, and the robot 1 stops. At the moving point MPc, the torque Tb and the angular difference Δθ12b are calculated. The following formulas (4) and (5) are satisfied at the two moving points MPb and MPc.

Δθ12a=Ta/k+BL (4)

Δθ12b=Tb/k+BL (5)

Here, the backlash component BL can be considered to be constant at the moving point MPb and the moving point MPc. Based on the formulas (4) and (5), the proportionality constant k can be obtained by the following formula (6).

k=(Ta−Tb)/(Δθ12a-Δθ12b) (6)

By such a method, the proportionality constant k can be previously obtained for each speed reducer. The torsion angle calculation unit 56 can calculate the torsion angle θt, by formula (2), using the proportionality constant k, the position and posture of the robot 1 acquired by the state acquisition unit 52, and the angular velocity of the servomotor 27.

The variable setting unit 53 can set, as a variable, a value obtained by subtracting the torsion angle θt from the angular difference Δθ12 based on the output of the first encoder 23 and the output of the second encoder 24 (Δθ12−θt). The determination unit 54 can perform the first determination control operation to the third determination control operation using the calculated variable. By using, as a variable for determining an abnormality, the variable obtained by subtracting the torsion angle from the angular difference, the effect of torsion in the speed reducer can be eliminated. The abnormality in the speed reducer can be determined with high accuracy. In addition, the estimation unit 55 can estimate when the abnormality will occur, using the calculated variable. The estimation unit 55 can more accurately estimate when the failure will occur.

Subsequently, the second abnormality detection control operation for detecting an abnormality of the speed reducer 30 in this embodiment will be described. In the second abnormality detection control operation of this embodiment, variables that do not include the rotation angle obtained from the output of the second encoder 24 but include the rotation angle obtained from the output of the first encoder 23 are used so as to determine the abnormality of the speed reducer 30. The first determination control operation to the third determination control operation for determining the abnormality of the speed reducer 30 are the same as the first abnormality detection control operation. Further, the estimation control operation for estimating the time in which an abnormality will occur in the speed reducer 30 is the same as the above-described control operations.

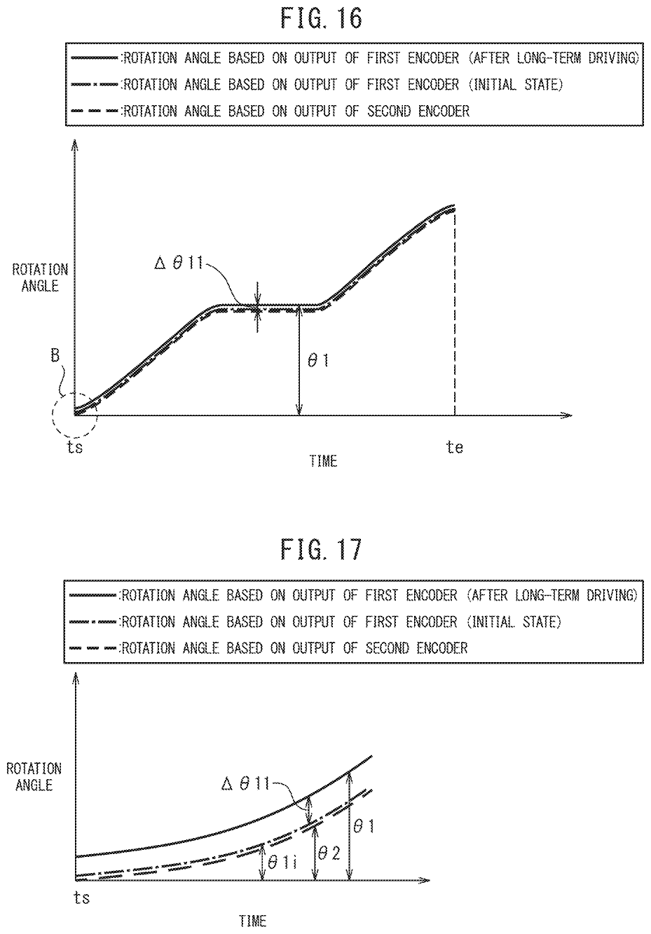

FIG. 16 shows a graph of the rotation angle with respect to the time for explaining the second abnormality detection control operation in this embodiment. FIG. 16 shows an example in which the servomotor 27 stops while the robot 1 operates. The vertical axis is the rotation angle based on the output of each encoder. FIG. 17 shows an enlarged view of the graph in the vicinity of the time when the rotation angle measurement is started. FIG. 17 is an enlarged view of a portion B in FIG. 16. FIGS. 16 and 17 show, as the initial state of the speed reducer 30, the rotation angle based on the output of the first encoder 23 when the speed reducer 30 is new. Further, the rotation angle, based on the output of the first encoder 23, when the speed reducer 30 is driven for a long time and the wear progresses is described.

Referring to FIGS. 16 and 17, in this embodiment, the rotational position of the servomotor 27 is controlled based on the rotational position output from the second encoder 24. Thus, the rotation angle θ2 based on the output of the second encoder 24 when the robot 1 performs a predetermined operation does not substantially change even if the wear of the parts of the speed reducer 30 progresses. On the other hand, as the wear of the parts of the speed reducer 30 progresses, the difference between the rotation angle θ1 based on the output of the first encoder 23 and the rotation angle θ2 based on the output of the second encoder 24 gradually changes, i.e., increases. In the example shown in FIGS. 16 and 17, the rotation angle θ1 increases with respect to the rotation angle θ2.

In the second abnormality detection control operation, the abnormality of the speed reducer 30 is determined based on the rotation angle θ1 obtained from the output of the first encoder 23. In the second abnormality detection control operation, the variable setting unit 53 sets variables including the rotation angle θ1 obtained from the output of the first encoder 23. Based on the variables set by the variable setting unit 53, the determination unit 54 determines whether the speed reducer 30 is abnormal in the above-described first determination control operation to the third determination control operation.

The first variable in the second abnormality detection control operation is the rotation angle θ1 obtained by dividing the rotation angle obtained from the output of the first encoder 23 by the reduction ratio. The determination unit 54 determines the abnormality of the speed reducer 30 based on the rotation angle θ1. For example, in the first determination control operation shown in FIG. 10, it can be determined that the speed reducer 30 is abnormal when the rotation angle θ1 exceeds a predetermined determination value.

As the second variable in the second abnormality detection control operation, a difference Δθ11 between the predetermined rotation angle θ1i obtained from the output of the first encoder 23 when the speed reducer 30 is normal and the rotation angle θ1 obtained from the current output of the first encoder 23 can be employed. In this example, a value obtained by subtracting the rotation angle θ1i when the speed reducer 30 is normal from the current rotation angle θ1 (θ1−θ1i) is used as the difference Δθ11. As the predetermined rotation angle based on the output of the first encoder 23 when the speed reducer 30 is normal, the rotation angle based on the output of the first encoder 23 in the initial state when the speed reducer 30 is new can be employed. The determination unit 54 determines the abnormality of the speed reducer 30 based on the difference Δθ11 in the rotation angle. Thus, the amount of change in the rotation angle obtained from the output of the first encoder 23 may be employed as a variable.

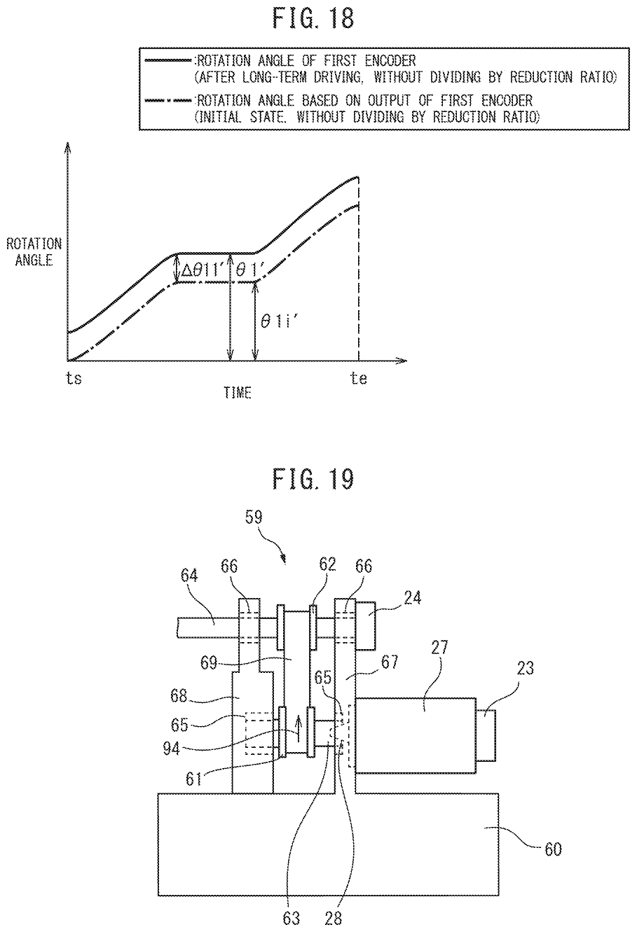

FIG. 18 shows a graph of the rotation angle based on the output of the first encoder. The rotation angle shown in FIG. 18 is the difference in the rotational position (phase) output from the first encoder 23. In the second abnormality detection control operation, since the determination is made based on the output of the first encoder 23, it is not necessary to divide the rotation angle by the reduction ratio. In FIG. 18, the rotation angle is not divided by the reduction ratio. A predetermined rotation angle θ1i′ based on the output of the first encoder 23 when the speed reducer 30 is normal and a rotation angle θ1′ based on the output of the first encoder 23 when the wear of the parts progresses are shown.

In the second abnormality detection control operation, the variable setting unit 53 can set, as a third variable, the rotation angle θ1′ output from the first encoder 23. The determination unit 54 determines the abnormality of the speed reducer 30 based on the rotation angle θ1′. Alternatively, the variable setting unit 53 can set, as a fourth variable, the difference (θ1′-θ1i′) between the rotation angle θ1i′ when the speed reducer 30 is normal and the current rotation angle θ1′, i.e., the difference Δθ11′ in the rotation angle. The determination unit 54 determines the abnormality of the speed reducer 30 based on the difference Δθ11′ in the rotation angle. Thus, in the second abnormality detection control operation, an abnormality can be determined without using the output from the second encoder.

Note that, in the second abnormality detection control operation, the difference between the rotation angle when the speed reducer 30 is normal and the current rotation angle may be a positive value or a negative value. Furthermore, the difference between the rotation angle when the speed reducer 30 is normal and the current rotation angle is not limited to the above-described embodiment, and may be a value obtained by subtracting the current rotation angle from the rotation angle when the speed reducer 30 is normal, or the absolute value of a value obtained by subtracting one rotation angle from the other rotation angle.

In this embodiment, a device that detects an abnormality in the speed reducer at the joint between the swivel base and the lower arm is described as an example, but the present invention is not limited to this embodiment. The abnormality detection device of this embodiment can be applied to detection of an abnormality of the speed reducer at any joint.

The abnormality detection device of this embodiment can detect an abnormality in a power transmission mechanism such as a speed reducer at an early stage. In particular, backlash due to the wear of parts can be detected with high accuracy. Alternatively, it is possible to detect abnormalities due to deformation of parts and the like. For example, a plan for maintenance or inspection of the speed reducer can be established before a failure such as tooth skipping occurs in the speed reducer. Further, it is possible to plan the maintenance or inspection of the speed reducer before the accuracy of controlling the position and posture of the robot reduces. Further, when a second encoder is disposed in order to precisely control the position of the components of the machine, it is possible to detect an abnormality in the power transmission mechanism without arranging an additional sensor.

The abnormality detection device of this embodiment can be applied to any machine having an electric motor and a power transmission mechanism. The power transmission mechanism that transmits the rotational force of the electric motor to another member is not limited to the speed reducer, and any mechanism that transmits the rotational force of the electric motor can be employed. For example, as the power transmission mechanism, a belt drive mechanism, a mechanism including a universal joint, a link mechanism, or the like can be employed in addition to the mechanism including gears. Subsequently, a power transmission mechanism including pulleys and belts will be described.

FIG. 19 shows a schematic side view of the electric motor and another power transmission device. In the example shown in FIG. 19, a belt-driven mechanism is employed in order to provide a rotational force to a predetermined portion of the machine. The machine includes the servomotor 27 and a power transmission mechanism 59 that transmits the rotational force of the servomotor 27. The servomotor 27 is secured to a support portion 67 of a base 60.

The power transmission mechanism 59 includes an input shaft 63 coupled to the output shaft 28 of the servomotor 27, and an output shaft 64 that transmits a rotational force to another member. The input shaft 63 is supported by the support portions 67 and 68 of the base 60 via bearings 65. The output shaft 64 is supported by the support portions 67 and 68 of the base 60 via bearings 66.

A pulley 61 is attached to the input shaft 63. A pulley 62 is attached to the output shaft 64. A belt 69 engages with the pulley 61 and the pulley 62. The belt 69 is driven by the servomotor 27 and moves in the direction indicated by arrow 94. The rotational force of the input shaft 63 is transmitted to the output shaft 64 by the belt 69. The rotational speed changes based on the size of the pulley 61 and the size of the pulley 62.

The first encoder 23 is attached to the servomotor 27 in order to detect the rotation angle of the input shaft 63 of the power transmission mechanism 59. Further, a second encoder 24 is attached to the output shaft 64 in order to detect the rotation angle of the output shaft 64 of the power transmission mechanism 59.

In the power transmission mechanism 59, the phase of the output shaft 64 may deviate from the phase of the input shaft 63 due to, for example, deterioration of the belt 69. For example, the deflection of the belt 69 may cause the rotation angle of the input shaft 63 to deviate from the rotation angle of the output shaft 64. Alternatively, the bearings 65 and 66 may wear out. For such a power transmission mechanism 59 as well, the abnormality detection device can detect an abnormality of the power transmission mechanism 59 by performing a control operation similar to the above-described first abnormality detection control operation and the second abnormality detection control operation. Further, by performing the above-described estimation control operation, it is possible to estimate when an abnormality will occur.

The above embodiments can be combined as appropriate. In each of the above figures, the same reference numerals are given to the same or equivalent parts. Noted that the above embodiments are described as examples and do not limit the invention. Further, the embodiments include modifications of the embodiments described in the claims.

### REFERENCE SIGNS LIST

4 robot controller
23 first encoder
24 second encoder
27 servomotor
28 output shaft
30 speed reducer
32 input shaft
33 output shaft
41 operation program
43 operation control unit
51 detection unit
53 variable setting unit
54 determination unit
55 estimation unit
56 torsion angle calculation unit
59 power transmission mechanism
63 input shaft
64 output shaft
65, 66 bearings
81 approximation line

1. An abnormality detection device for detecting an abnormality in a power transmission mechanism that transmits a rotational force output by an electric motor, comprising:
a first rotational position detector for detecting a rotation angle of an input shaft of the power transmission mechanism;
a second rotational position detector for detecting a rotation angle of an output shaft of the power transmission mechanism;
an operation control unit for controlling an operation of the electric motor; and
a detection unit for detecting an abnormality in the power transmission mechanism based on the output of the first rotational position detector and the output of the second rotational position detector, wherein
the operation control unit controls the electric motor so that the position obtained from the output of the second rotational position detector corresponds to the position defined in an operation program, and
the detection unit includes: a variable setting unit for setting a variable including an angular difference that is a difference between the rotation angle obtained from the output of the first rotational position detector and the rotation angle obtained from the output of the second rotational position detector, based on the output of the first rotational position detector, the output of the second rotational position detector, and a reduction ratio of the power transmission mechanism; and a determination unit for determining whether the power transmission mechanism is abnormal, based on the variable.

2. The abnormality detection device according to claim 1, wherein the variable setting unit sets the angular difference as the variable.

3. The abnormality detection device according to claim 1, wherein the variable setting unit calculates, as the variable, a difference or ratio between the current angular difference of the power transmission mechanism and the predetermined angular difference when the power transmission mechanism is normal.

4. The abnormality detection device according to claim 1, wherein the variable setting unit calculates, as the variable, a value obtained by dividing the difference between the current angular difference of the power transmission mechanism and the predetermined angular difference when the power transmission mechanism is normal by the predetermined angular difference when the power transmission mechanism is normal.

5. The abnormality detection device according to claim 2, wherein the detection unit includes a torsion angle calculation unit for calculating a torsion angle between the input shaft and the output shaft based on torque applied to the power transmission mechanism, and the variable setting unit calculates, as the variable, a value obtained by subtracting the torsion angle from the angular difference.

6. An abnormality detection device for detecting an abnormality in a power transmission mechanism that transmits a rotational force output by an electric motor, comprising:
a first rotational position detector for detecting a rotation angle of an input shaft of the power transmission mechanism;
a second rotational position detector for detecting a rotation angle of an output shaft of the power transmission mechanism;
an operation control unit for controlling an operation of the electric motor; and
a detection unit for detecting an abnormality in the power transmission mechanism based on the output of the first rotational position detector, wherein
the operation control unit controls the electric motor so that the position obtained from the output of the second rotational position detector corresponds to the position defined in an operation program, and
the detection unit includes: a variable setting unit for setting a variable that includes the rotation angle obtained from the output of the first rotational position detector but does not include the rotation angle obtained from the output of the second rotational position detector; and a determination unit for determining whether the power transmission mechanism is abnormal based on the variable.

7. The abnormality detection device according to claim 6, wherein the variable setting unit calculates, as the variable, the rotation angle obtained by dividing the rotation angle obtained from the output of the first rotational position detector by a reduction ratio.

8. The abnormality detection device according to claim 6, wherein the variable setting unit sets, as the variable, the rotation angle output from the first rotational position detector.

9. The abnormality detection device according to claim 6, wherein the variable setting unit calculates, as the variable, a difference between the current rotation angle obtained from the output of the first rotational position detector and a predetermined rotation angle obtained from the output of the first rotational position detector when the power transmission mechanism is normal.

10. The abnormality detection device according to claim 1, wherein the determination unit determines that the power transmission mechanism is abnormal when the variable deviates from a predetermined determination range.

11. The abnormality detection device according to claim 1, wherein the determination unit determines that the power transmission mechanism is abnormal when the rate of change of the variable with respect to the number of executions or the drive time of work deviates from a predetermined determination range.

12. The abnormality detection device according to claim 1, wherein the detection unit includes an estimation unit for estimating the number of executions or the drive time of work in which an abnormality will occur in the future, and
the estimation unit calculates an approximation line indicating the trend of change of the variable based on a value of the variable with respect to the number of executions or the drive time of the past work, and estimates, as the number of executions or the drive time of work in which an abnormality will occur in the future, the number of executions or the drive time of work in which the approximation line deviates from a predetermined determination range.
